(19) United States
(12) Patent Application Publication
(10) Pub. No.: US 2025/0278689 A1
(43) Pub. Date: Sep. 4, 2025

(54) SUPPLY CHAIN OPTIMIZATION WITH REINFORCEMENT LEARNING

(71) Applicant: Hoffmann-La Roche Inc., Little Falls, NJ (US)

(72) Inventors: Patric HAMMLER, Rheinfelden (CH); Nicolas Oliver RIESTERER, Ebringen (DE)

(73) Assignee: Hoffmann-La Roche Inc., Little Falls, NJ (US)

(21) Appl. No.: 19/085,993

(22) Filed: Mar. 20, 2025

Related U.S. Application Data
(63) Continuation of application No. PCT/EP2023/076443, filed on Sep. 26, 2023.

(30) Foreign Application Priority Data
Sep. 28, 2022 (EP) 22198235.8

(51) Int. Cl. G06Q 10/067; G06Q 10/087; G06Q 30/0283

(52) U.S. Cl. CPC G06Q 10/067; G06Q 10/087; G06Q 30/0283

(57) ABSTRACT

The present invention relates to systems and methods to optimize a supply chain. Various embodiments of the present invention relate to systems and methods to optimize a multi-distribution-level supply chain and, more specifically but not limited, to systems and methods to optimize a multi-distribution-level supply chain via a machine-learning model based on reinforcement learning.

The present invention relates to systems and methods to optimize a supply chain. Various embodiments of the present invention relate to systems and methods to optimize a multi-distribution-level supply chain and, more specifically but not limited, to systems and methods to optimize a multi-distribution-level supply chain via a machine-learning model based on reinforcement learning.

The supply chain optimization problem consists of finding an optimal reorder policy that defines when to order which amount of stock, i.e. the reorder point and the reorder quantity. Standard supply chain optimization techniques are able to find a parametrized policy, whereby the reorder point and reorder quantity are static and do not change based on structural and environmental changes in the supply chain. The adoption of static parametrized policies risks neglecting the existence of special situations that require special coping strategies such as logistics challenges and other environmental effects.

To address this issue, state-of-the-art supply chain optimization techniques aim at finding dynamic policies by incorporating a fundamental understanding of the dynamics of the supply chain. In the framework of Artificial Intelligence (AI) algorithms, Machine-Learning (ML) models are employed to find dynamic policies that can interpret the current state of the supply chain based on expectations about the future. To this end, Deep Reinforcement Learning (DRL) models are particularly well suited, as they leverage the high representational capacities of Deep Neural Networks (DNN) to maintain a fundamental understanding about the large state-and action-spaces typical of the real-world supply chains. However, due to the difficulty to implement a high-dimensional state space with a high number of influencing, partially stochastic factors, such as for example demand and lead time, most proposed methods assume small-scale or highly simplified supply chains. This is particularly the case for multi-distribution-level supply chains, in particular multi-echelon supply chains, compared to simple single-echelon supply chains. Recent efforts focused on applying DRL on supply chains show that DRL performs in a similar manner as heuristic approaches¹, but only assuming a static and known demand distribution.

### CITED LITERATURE

¹Gijsbrechts J et al, Can deep reinforcement learning improve inventory management? Performance on dual sourcing, lost sales and multi-echelon problems.

http://dx.doi.org/10.2139/ssrn.3302881, 2021.

Thus there is a need for an automatized fully-dynamic supply chain optimization that performs when scaled to environments that mimic the complexities of real-world supply chains.

### BRIEF DESCRIPTION OF THE DRAWINGS

FIG. 1 illustrates an exemplary instance of a system for supply chain optimization, in accordance with an example of the invention.

FIG. 2 depicts a block diagram that illustrates an exemplary data processing apparatus for supply chain optimization, in accordance with an example of the invention.

FIG. 3 depicts the typical cycle of Reinforcement Learning, in accordance with an example of the invention.

FIG. 4 depicts a set of simplified schemes of a multi-distribution-level supply chain, in accordance with an example of the invention.

FIG. 5 illustrates a supply chain optimization environment, in accordance with an example of the invention.

FIG. 6 shows an exemplary workflow for the optimization of a supply chain, in accordance with an example of the invention.

FIG. 7 shows an exemplary workflow for training a model for the optimization of a supply chain, in accordance with an example of the invention.

FIG. 8 shows an exemplary workflow for the generation of a supply chain digital twin, in accordance with an example of the invention.

### DETAILED DESCRIPTION

The present invention relates to systems and methods to optimize a supply chain. Various embodiments of the present invention relate to systems and methods to optimize a multi-distribution-level supply chain and, more specifically but not limited, to systems and methods to optimize a multi-distribution-level supply chain via a machine-learning model based on reinforcement learning.

Supply chains are a major cost driver for manufacturing companies world-wide. As such, their optimization is one of the key objectives for operations departments impacting both operational cost and revenue. The result of the optimization process is a policy that defines when to order what amount of stock to keep the cost as low as possible while making sure that incoming demand is satisfied. This can be understood as a tuple (r, Q) consisting of a reorder point r, i.e. a threshold level of Inventory On Hand (IOH) at which to order Q amount of stock. In the context of the present invention, terms such as order, reorder and/or stock, restock, or equivalents or derivations, are treated as synonyms, and stock comprises one or multiple products of the supply chain.

Supply chains are composed by nodes and edges. Nodes represent possible stocking points, such as for example warehouses and/or distribution centers and/or manufacturing centers. Edges represent relations and dependencies between nodes, such as for example product exchanges, information updates. In the context of the present invention, edges are treated as equivalents to relations, dependencies, connections, interconnections. For the purpose of the present invention, edges and equivalents assume the technical meaning of data flows, data exchange processes, data exchange updates, including but not limited to automatized data flows, automatized data exchange processes, automatized data exchange updates, regular data flows, regular data exchange processes, regular data exchange updates. Single-echelon supply chains are supply chains with one node, or with multiple but independent nodes. Multi-echelon supply chains are supply chains with multiple dependent nodes. In the context of the present invention, multi-distribution-level supply chains include but are not limited to multi-echelon supply chains. In the context of the present invention, Single-Echelon Inventory Optimization (SEIO) refers to a local optimization of single nodes of the supply chain. By considering its demand requirements, every warehouse determines the ideal point and amount of restocking without taking into account dependencies and interactions with other warehouses or distribution centers. In the context of the present invention, Multi-Echelon Inventory Optimization (MEIO) refers to an optimization that assumes a holistic perspective in which the ideal policies are determined jointly by explicitly taking into consideration interrelationships among warehouses and/or distribution centers. In this context, the present invention is a holistic optimization, since it prevents inventory systems making egoistic decisions at the cost of neighboring inventory systems. In the context of the present invention, inventory system can refer, for example and by no way of limitation, to one or multiple supply chains, one or multiple nodes of a supply chain or of multiple supply chains.

Mathematically, MEIOs are expressed for the purpose of the present invention as Markov Decision Problems (MDP) via a 4-tuple (S, A, T, R), where:
S denotes the state space, i.e. the set of situations s∈S the supply chain can be in, which are characterized by a set of observable features, such as current IOH levels, current demand, reordered but not yet delivered open order quantities, backlogged quantities for unserved demand;
A is the set of actions used to control the state; in the MEIO example, an action a∈A denotes the reorder decision (whether to reorder and how much);
T is the transition probability that describes the environment's dynamics, such as for example stochastic demand and lead time and static node properties such as the maximum inventory capacity of a warehouse; by applying action a to state s a transition to a new state s′ is performed based on the transition probability T(s, a, s′);
R is the reward signal; the reward can depend on the state s, on the new state s′ and the action a, R(s, a, s′), and is used by the model to assess the quality of the action. In the context of the present invention, R assesses the holistic operational cost of the inventory system network.

In this framework, a policy π is a function π: S→A that maps from a state s to an action a.

In an embodiment, the present invention relates to systems and methods to automatize a scalable MEIO, i.e. to find optimal reorder policies which are dynamic, holistic and performant with supply chains of different scales. In the context of the present invention, scales of a supply chain refer to scales of complexity, comprising but not limited to complexity in terms of number of interacting inventory systems, number and hierarchy of nodes (e.g. warehouses, distribution centers, manufacturing centers), dynamics of the environment. In the context of the present invention, interactions within and among inventory systems and/or supply chains are equivalently defined as edges, data flows, data exchange processes, data exchange updates, including but not limited to automatized data flows, automatized data exchange processes, automatized data exchange updates, regular data flows, regular data exchange processes, regular data exchange updates.

In the context of the present invention, a virtual environment corresponds to a virtual version of a real-world environment. The virtual version can be a digital version of the real-world environment. A simulated virtual environment of a supply chain is a virtual version of the supply chain that mimics the real-world supply chain conditions, and can be obtained by inputting supply chain data such as the supply chain structure and configuration to a virtual environment of the supply chain. In the context of the present invention, supply chain structure comprises supply chain nodes and edges; supply chain configuration comprises supply chain dynamics, such as for example stochastic demand and lead time. In some embodiments of the present invention, supply chain structure and configuration are used interchangeably. In the context of the present invention, a state of the supply chain comprises the supply chain structure and supply chain configuration at a given point in time. The supply chain structure can be obtained with real-world data from the supply chain. The supply chain configuration at a given point in time can be obtained with real-time data from the supply chain, where real-time data are real-world data updated in real time.

In an embodiment of the present invention, the simulated virtual environment is Markovian, i.e. has the Markov property. A system has the Markov property if the conditional probability distribution of future states depends only upon the present state; that is, given the present, the future of the system does not depend on the past.

A virtual representation of the state of the supply chain is obtained by feeding the simulated virtual environment of the supply chain with real-time data that characterize the state of the supply chain in real time, such as for example current IOH levels, current demand, reordered but not yet delivered open order quantities also referred to as open order situation, backlogged quantities for unserved demand.

In an embodiment of the present invention, the virtual representation of the state of the supply chain is a digital twin. A digital twin is a real-time virtual representation of a real-world physical system or process that serves as the indistinguishable digital counterpart of it for practical purposes, such as system simulation, integration, testing, monitoring and maintenance. The digital twin of a supply chain is among all possible virtual representations of the state of a supply chain the one that is indistinguishable from the state of the real-world supply chain, and it can be obtained by feeding the simulated environment of the supply chain with all real-time data that characterize exhaustively the state of the supply chain in real time. Interfacing an optimizer with a digital twin of the supply chain allows for a much quicker optimization of the supply chain than when applying the optimizer directly to the real-world supply chain, resulting in higher levels of performance. In an example of the present invention, a DRL optimizer is trained on thousands of years of simulation time. By interfacing the optimizer with the digital twin, risk mitigation can be more easily assessed. In an example of the present invention, the digital twin can be updated with actions corresponding to very negative rewards, thus allowing the optimizer to learn by exploring randomly negative experiences without impacting the real-world supply chain.

In an embodiment of the present invention, the model is an AI algorithm. In a further embodiment of the present invention, the AI algorithm is a ML algorithm. In a further embodiment of the present invention, the ML algorithm is a DNN. In a further embodiment of the present invention, the DNN is a DRL model. In an example of the present invention, the DRL model is implemented via a Stable-Baselines3 implementation (https://stable-baselines3.readthedocs.io/en/master/), for example but by no way of limitation A2C, DDPG, DQN, HER, PPO, SAC, TD3.

In an embodiment of the present invention, the trained model is trained via an optimizer. In an embodiment of the present invention, the optimizer is Stochastic Gradient Descent. In an embodiment of the present invention, the optimizer is an ADAM optimizer. In other embodiments of the present invention, the optimizer can be an AdaGrad optimizer, a Root Mean Square Propagation optimizer, a Layer-wise Adaptive Rate Scaling (LARS) optimizer. In an embodiment of the present invention, the optimizer is constrained by the environment's dynamics, such as for example stochastic demand, lead times, specific nodes properties like the maximum inventory capacity of a warehouse. Lead times comprise shipment lead-time estimates.

In the context of the present invention, exemplary actions that can be taken on a representation of the state of the supply chain to obtain a modified representation of the state of the supply chain comprise a reorder policy, i.e. a reorder point and/or a reorder quantity, both on a per-node basis and aggregated across nodes. In an embodiment, a reorder point can be defined in terms of a threshold of IOH that triggers a reorder. In another embodiment, a reorder point can be defined in terms of an amount of time that triggers a reorder. In an embodiment, a reorder quantity can refer to the quantity of restocking of a single product or several products.

In an embodiment of the present invention, a reward function is a cost function. In the context of the present invention and of ML models in general, a cost function is used to evaluate the performance of the ML model. In another embodiment of the present invention, the cost function comprises the costs of holding, reorder, overload and shortage. In another embodiment of the present invention, the cost function comprises the transportation costs between supply chain nodes.

In an embodiment of the present invention, an optimal action can be the action that corresponds to the maximum value of the reward function. In another embodiment of the present invention, an optimal action can be the action that corresponds to the minimum value of the reward function. In an embodiment of the present invention, a reward function is coupled with an entropy function, and an optimal action can be the action that corresponds to the maximum value of the reward function and the maximum value of entropy.

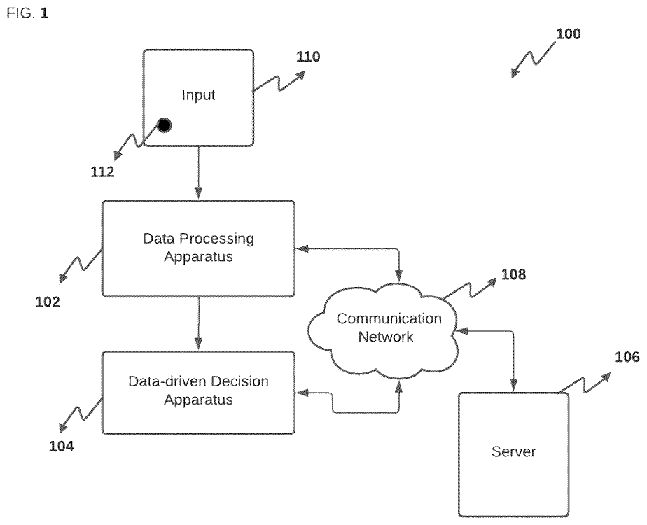

FIG. 1 illustrates an exemplary instance of a system for supply chain optimization, in accordance with an example of the invention.

With reference to FIG. 1, the system 100 can include a data processing apparatus 102, a data-driven decision apparatus 104, a server 106 and a communication network 108. The data processing apparatus 102 can be communicatively coupled to the server 106 and the data-driven decision apparatus 104 via the communication network 108. In other embodiments, the data processing apparatus 102 and the data-driven decision apparatus 104 can be embedded in a single apparatus. The data processing apparatus 102 can receive as input a set of data 110 comprising real-time data 112. In other embodiments, the data 110 can be stored in the server 106 and sent from the server 106 to the data processing apparatus 102 via the communication network 108.

The data processing device 102 can be designed to receive the data 110 and use them to create a virtual environment of the supply chain. The virtual environment can be a digital twin. Data 110 can comprise the number of supply chain nodes and their hierarchy. The data processing device 102 can allow for the pre-processing of the real-time data 112, for example for their conversion into secured digital messages, and for their implementation in the virtual supply chain environment. Real-time data 112 can comprise data from databases, data lakes, data warehouses, cloud infrastructures, blockchain. The data processing device 102 can be designed to receive real-time data 112 via integrated Internet of Things (IoT), Industrial Internet of Things (IIoT), CyberPhysical Systems (CPS), Blockchain technology, cloud computing, augmented reality and/or virtual reality. Examples of the data processing device 102 include but are not limited to a computer workstation, a handheld computer, a mobile phone, a smart appliance.

The data-driven decision apparatus 104 can comprise software, hardware or various combinations of these. The data-driven decision apparatus 104 can be designed to receive as input the output of the data processing device 102 and perform a predictive and prescriptive analysis for supply chain optimization via at least one trained model. In an embodiment, the data-driven decision apparatus 104 can be able to access from the server 106 the stored data. The data-driven decision apparatus 104 can be designed to receive real-time data 112 via integrated Internet of Things (IoT), Industrial Internet of Things (IIoT), CyberPhysical Systems (CPS), Blockchain technology, cloud computing, augmented reality and/or virtual reality. Examples of the data-driven decision apparatus 104 include but are not limited to computer workstation, a handheld computer, a mobile phone, a smart appliance.

The server 106 can be configured to store data. In some embodiments, the server 106 can also store metadata related to the data. The server 106 can be designed to send the data 110 to the data processing apparatus 102 via the communication network 108, and/or to receive the output features of the digital image 110 from the data processing apparatus 102 via the communication network 108. The server 106 can also be configured to receive and store the metadata associated with the data from the data-driven decision apparatus 104 via the communication network 108. Examples of the server 106 include but are not limited to application servers, cloud servers, database servers, file servers, and/or other types of servers.

The communication network 108 can comprise the means through which the data processing apparatus 102, the data-driven decision apparatus 104 and the server 106 can be communicatively coupled. Examples of the communication network 108 include but are not limited to the Internet, a cloud network, a Wi-Fi network, a Personal Area Network (PAN), a Local Area Network (LAN) or a Metropolitan Area Network (MAN). Various devices of the system 100 can be configured to connect with the communication network 108 with wired and/or wireless protocols. Examples of protocols include but are not limited to Transmission Control Protocol/Internet Protocol (TCP/IP), Hypertext Transfer Protocol (HTTP), File Transfer Protocol (FTP), Bluetooth (BT).

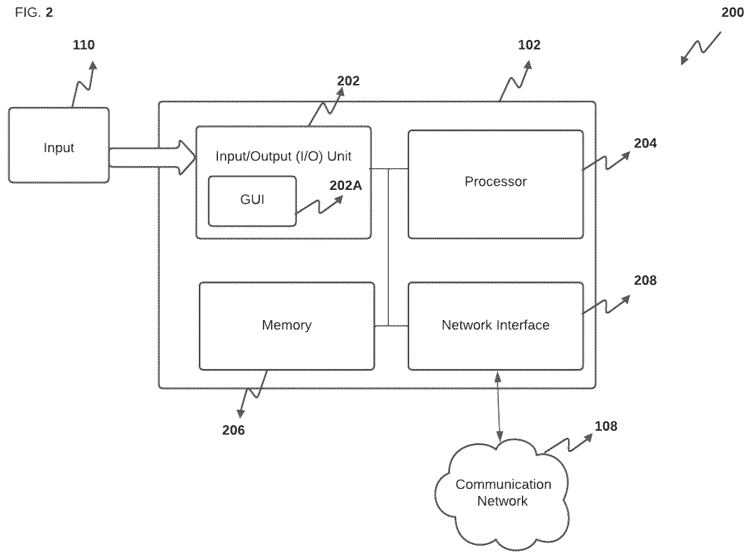

FIG. 2 depicts a block diagram that illustrates an exemplary data processing apparatus for supply chain optimization, in accordance with an example of the invention.

With reference to FIG. 2, it is shown a block diagram 200 of the data processing apparatus 102. The data processing apparatus 102 can include an Input/Output (I/O) unit 202 further comprising a Graphical User Interface (GUI) 202A, a processor 204, a memory 206 and a network interface 208. The processor 204 can be communicatively coupled with the memory 206, the I/O unit 202 and the network interface 208.

The I/O unit 202 can comprise suitable logic, circuitry and interfaces that can act as interface between a user and the data processing apparatus 102. The I/O unit 202 can be configured to receive data 110 comprising real-time data 112. In an embodiment, the I/O unit 202 can be configured to receive data 110 comprising real-time data 112 via integrated Internet of Things (IoT), Industrial Internet of Things (IIoT), CyberPhysical Systems (CPS), Blockchain technology, cloud computing, augmented reality and/or virtual reality. The I/O unit 202 can include different operational components of the data processing apparatus 102. The I/O unit 202 can be programmed to provide a GUI 202A for user interface. Examples of the I/O unit 202 can include, but are not limited to, a touch screen, a keyboard, a mouse, a joystick, a microphone, and a display screen, like for example a screen displaying the GUI 202A.

The GUI 202A can comprise suitable logic, circuitry and interfaces that can be configured to provide the communication between a user and the data processing apparatus 102. In some embodiments, the GUI can be displayed on an external screen, communicatively or mechanically coupled to the data processing apparatus 102. The screen displaying the GUI 202A can be a touch screen or a normal screen.

The processor 204 can comprise suitable logic, circuitry and interfaces that can be configured to execute programs stored in the memory 206. The programs can correspond to sets of instructions for data processing operations. In some embodiments, the programs can correspond to a set of instructions for executing a machine-learning model, and in particular a deep learning model, and in particular a reinforcement learning model. The processor 204 can be built on a number of processor technologies known in the art. Examples of the processor 204 can include, but are not limited to, Graphical Processing Units (GPUs), a Central Processing Units (CPUs), motherboards, network cards.

The memory 206 can comprise suitable logic, circuitry and interfaces that can be configured to store programs to be executed by the processor 204. Additionally, the memory 206 can be configured to store the data 110 and/or its associated metadata. Examples of the implementation of the memory 206 can include, but are not limited to, Random Access Memory

(RAM), Read Only Memory (ROM), Hard Disk Drive (HDD), Solid State Drive (SDD) and/or other memory systems.

The network interface 208 can comprise suitable logic, circuitry and interfaces that can be configured to enable the communication between the data processing apparatus 102, the data-driven decision apparatus 104 and the server 106 via the communication network 108. The network interface 208 can be implemented in a number of known technologies that support wired or wireless communication with the communication network 108. The network interface 208 can include, but is not limited to, a computer port, a network interface controller, a network socket or any other network interface systems.

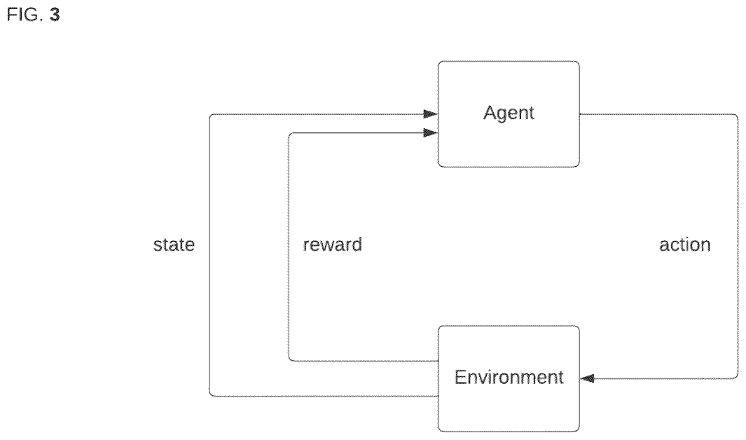

FIG. 3 depicts the typical cycle of Reinforcement Learning, in accordance with an example of the invention. In the typical RL scenario an agent takes an action in an environment, which is interpreted into a reward and a representation of the state, which are fed back into the agent. The purpose of RL is for the agent to learn an optimal, or nearly-optimal, policy that optimizes, for example maximizes, the reward function or other user-provided reinforcement signal that accumulates from the immediate rewards. In an exemplary instance of the present invention, the agent takes an action in a real-world supply chain environment. In an embodiment, the supply chain environment is a simulated virtual environment of the supply chain, and actions corresponding to very negative rewards can be allowed, thus allowing the agent to learn by exploring randomly negative experiences without impacting the real-world supply chain.

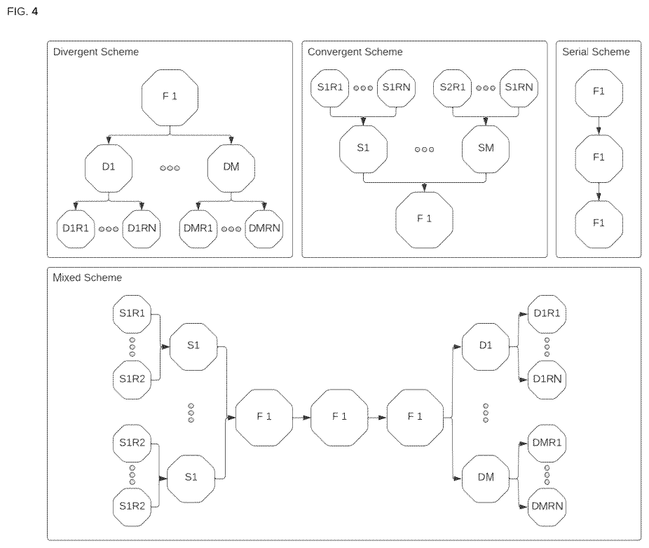

FIG. 4 depicts a set of simplified schemes of a multi-distribution-level supply chain, in accordance with an example of the invention. The divergent scheme can consist of one factory node providing supplies or data to M distribution warehouses whereas the distribution warehouses supply N retail warehouses. Formally, the tuple (M, N) refers to each of the M distribution warehouses supplying N distinct retail warehouses. The convergent scheme can consist of N retail warehouses providing supplies or data to M distribution warehouses, which in turn provide supplies or data to the factory node. The serial scheme can consist in several nodes, for example factory nodes, exchanging supplies or data in a linear one-directional way. The mixed scheme can consist of a combination of multiple schemes.

In an embodiment the lead time, resembling the time to transport inventory from one node to another node, for example from one warehouse to another warehouse, can follow a normal distribution. In another embodiment, a factory layer with unlimited stock can be assumed, such that all requests from distribution warehouses can be served at any time. In an embodiment, the distribution warehouses are tasked with ordering stock from the factory and holding it for orders from retail warehouses. In a further embodiment, direct customer demand takes place at the retail warehouse only, with the daily demand being sampled from a distribution, for example a normal distribution. In this embodiment, lost sales and shortage cost can affect the retail level in first instance. In an embodiment, the total cost comprises shortage, holding, reordering and overload costs. In an embodiment, the optimization criterion encompasses the global cost, composed of the total costs of all inventory systems within the supply chain network.

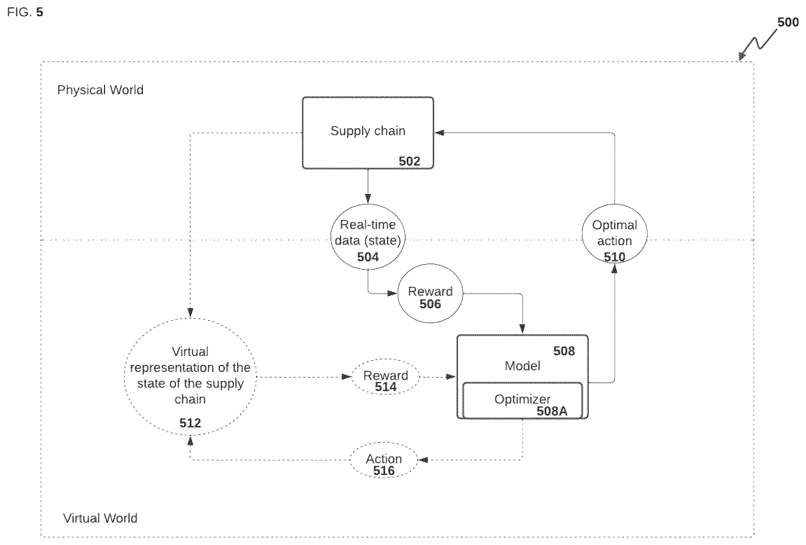

FIG. 5 illustrates a supply chain optimization environment, in accordance with an example of the invention. With reference to FIG. 5, it is shown a supply chain optimization environment 500. The environment is divided in physical and virtual world. The supply chain 502 is the real-world supply chain. Solid arrows correspond to the deployment workflow for the supply chain optimization, while dashed arrows correspond to the training workflow for the supply chain optimization. During deployment, real-time data 504, which define the state of the real-world supply chain, as well as the value of a reward function 506 are inputted to a model 508, the model 508 comprising an optimizer 508A. The model returns an optimal action 510, which is applied to the real-world supply chain resulting in an optimized supply chain. During training, a virtual representation of the state of the supply chain 512 is created, which together with the value of a reward function 514 is inputted to the model 508, the model 508 comprising an optimizer 508A. Based on the inputs 512 and 514, the model returns an action 516. The action 516 is performed on the virtual representation of the state of the supply chain to obtain a modified virtual representation of the state of the supply chain, for which an updated value of the reward function is calculated. The process of updating the virtual representation of the state of the supply chain, calculating the updated value of the reward function, running the model with the optimizer and obtaining from the model an updated action constitutes the training process. In an embodiment of the present example, the training process is repeated more than once. In an example of the present invention, the training process is repeated for the equivalent of thousands of years of simulation time.

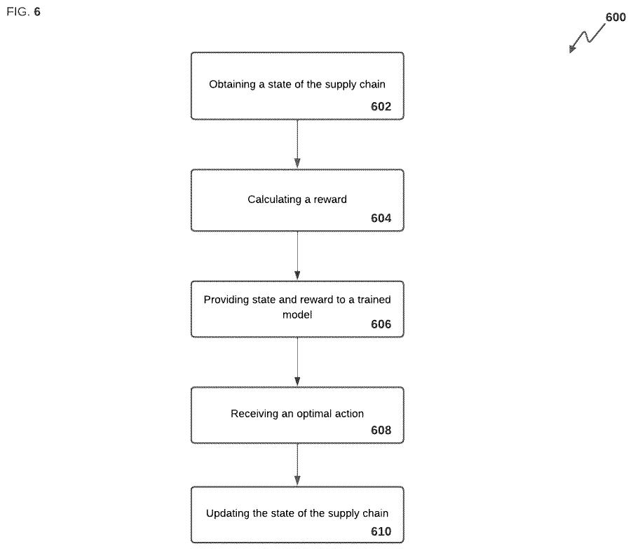

FIG. 6 shows an exemplary workflow for the optimization of a supply chain, in accordance with an example of the invention. With reference to FIG. 6, it is shown an exemplary workflow 600. At 602 a state of the supply chain is obtained. Obtaining a state of the supply chain comprises receiving the supply chain structure and configuration. The supply chain structure comprises supply chain nodes and edges; the supply chain configuration comprises supply chain dynamics, such as for example and by no way of limitation stochastic demand and lead time. The supply chain structure can be obtained in the form of real-world data. The supply chain configuration can be obtained in the form of real-time data. At 604 the value of a reward function is calculated based on the state of the supply chain. The reward function can be a cost function. The cost function can comprise the costs of holding, reorder, overload and shortage. The costs of holding, overload and shortage depend on the state of the supply chain, in particular on the supply chain dynamics. At 606 the state of the supply chain and the calculated value of the reward function are given as input to a trained model. The trained model can be an AI model, a ML model, a DRL model. The model can comprise an optimizer. At 608 an optimal action is received by the model. In some embodiments, an optimal action comprises an optimal reorder policy. In some embodiments of the present invention, the optimal action coincides with the trained model. In some embodiments of the present invention, the reward function depends on the possible actions, and the optimal action is the action that corresponds to the maximum value of the reward function. In some embodiments of the present invention, the reward function is a cost function comprising the costs of reorder, which depend on the action. In some embodiments of the present invention the optimal action is the action that corresponds to the maximum value of the cost function. At 610 the optimal action is performed on the state of the supply chain to obtain an updated state of the supply chain. The updated state of the supply chain can be the optimized supply chain.

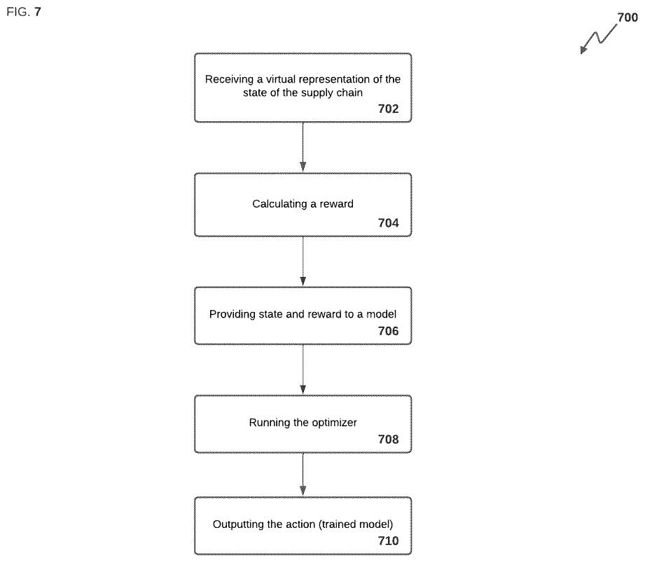

FIG. 7 shows an exemplary workflow for training a model for the optimization of a supply chain, in accordance with an example of the invention. With reference to FIG. 7, it is shown an exemplary workflow 700. At 702, a virtual representation of the state of the supply chain is obtained. The virtual representation of the state of the supply chain corresponds to the virtual environment of the supply chain updated with real-time data, such as for example but by no way of limitation current IOH levels, current demand, reordered but not yet delivered open order quantities, backlogged quantities for unserved demand. At 704 the value of a reward function is calculated based on the virtual representation of the state of the supply chain. The reward function can be a cost function. The cost function can comprise the costs of holding, reorder, overload and shortage. The costs of holding, overload and shortage depend on the state of the supply chain, in particular on the supply chain dynamics. At 706 the virtual representation of the state of the supply chain and the calculated value of the reward function are given as input to a model. The model can be untrained or partially trained. The model comprises an optimizer. At 708 the optimizer is run. The model can be an AI model, a ML model, a DRL model. The optimizer can be a stochastic gradient descent, an ADAM optimizer, or another optimizer. At 710 an action is returned by the model. In some embodiments, an action comprises a reorder policy. In some embodiments of the present invention, the reward function is a cost function comprising the costs of reorder, which depend on the action. In some embodiments, the action returned by the model is the optimal action. In some embodiments, the optimal action coincides with the trained model. In some embodiments of the present invention, the action returned by the model is performed on the virtual representation of the state of the supply chain to obtain a modified virtual representation of the state of the supply chain. In further embodiments of the present invention, steps 704 to 710 are repeated on the modified virtual representation of the state of the supply chain. In such embodiments, the optimal action is returned as final output, and the optimal action is the action that corresponds to the maximum value of the reward function. In some embodiments, the optimal action coincides with the trained model.

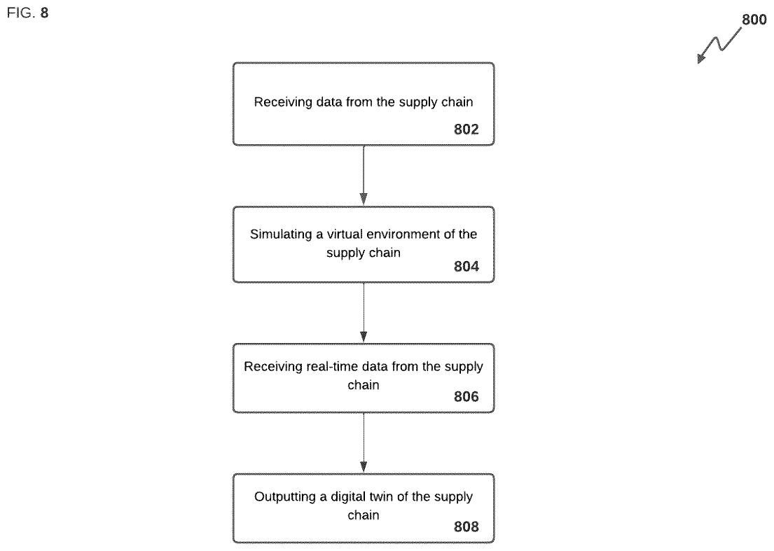

FIG. 8 shows an exemplary workflow for the generation of a supply chain digital twin, in accordance with an example of the invention. With reference to FIG. 8, it is shown an exemplary workflow 800. At 802 data are received from the supply chain. Data can comprise real-world data of the supply chain, for example the supply chain structure, comprising supply chain nodes and their data exchange processes. At 804 a virtual environment of the supply chain is simulated. The simulated virtual environment of the supply chain can be obtained by inputting the received supply chain data to a virtual environment of the supply chain. At 806 real-time data are received from the supply chain. Real-time data correspond to real-world data updated in real time. At 808 a supply chain digital twin is outputted. A supply chain digital twin can be the virtual representation of the state of the supply chain as obtained by updating the simulated virtual environment of the supply chain updated with the real-time data. Steps 806-808 can be performed more than once, thus the digital twin is updated more than once with real-time data, and can be performed automatically and at regular intervals or regular points in time. A supply chain digital twin can be used for understanding the real-world supply chain, testing supply chain design changes and development, monitoring risks and testing contingencies, discovering bottlenecks, planning transportation, optimizing inventory, analyzing resources, forecasting and testing operations.

### Embodiments

In the following, further particular embodiments of the present invention are listed.

1. In an embodiment, a computer-implemented method for optimizing a multi-distribution-level supply chain is disclosed, wherein the method comprises:
a. obtaining a state of the said supply chain, wherein the state is determined based on real-time data from the supply chain, wherein real-time data comprise data from databases, data lakes, data warehouses, cloud infrastructures, blockchain;
b. calculating a value of a reward function, wherein the value is associated to the state of the said supply chain;
c. providing the state of the said supply chain with the calculated value of the reward function to a trained model;
d. receiving from the trained model an optimal action, wherein the optimal action is associated with the provided state of the said supply chain and the calculated value of the reward function;
e. updating the state of the said supply chain with the optimal action.

2. In an embodiment, a computer-implemented method for optimizing a multi-distribution-level supply chain is disclosed, wherein the method consists of:
a. obtaining a state of the said supply chain, wherein the state is determined based on real-time data from the supply chain, wherein real-time data comprise data from databases, data lakes, data warehouses, cloud infrastructures, blockchain;
b. calculating a value of a reward function, wherein the value is associated to the state of the said supply chain;
c. providing the state of the said supply chain with the calculated value of the reward function to a trained model;
d. receiving from the trained model an optimal action, wherein the optimal action is associated with the provided state of the said supply chain and the calculated value of the reward function;
e. updating the state of the said supply chain with the optimal action.

3. In an embodiment, the method of any preceding embodiments is disclosed, wherein the steps are performed sequentially.

4. In an embodiment, the method of any preceding embodiments is disclosed, wherein the steps are performed in order.

5. In an embodiment, the method of any preceding embodiments is disclosed, wherein the real-time data are received at regular intervals.

6. In an embodiment, the method of any preceding embodiments is disclosed, wherein the multi-distribution-level supply chain is a multi-echelon supply chain.

7. In an embodiment, the method of any preceding embodiments is disclosed, wherein the reward function is a target cost function.

8. In an embodiment, the method of the preceding embodiment is disclosed, wherein the target cost function is a sum of the costs of holding, reorder, overload and shortage.

9. In an embodiment, the method of any preceding embodiments is disclosed, wherein the model comprises a deep reinforcement learning model.

10. In an embodiment, the method of any preceding embodiments is disclosed, wherein the model consists of a deep reinforcement learning model.

11. In an embodiment, the method of any preceding embodiments is disclosed, wherein the optimal action comprises a sequence of one or more steps of a reconfiguration of the supply chain.

12. In an embodiment, the method of any preceding embodiments is disclosed, wherein the optimal action consists of a sequence of one or more steps of a reconfiguration of the supply chain.

13. In an embodiment, the method of the preceding embodiment is disclosed, wherein the reconfiguration of the supply chain comprises a reorder policy.

14. In an embodiment, the method of embodiment 12 is disclosed, wherein the reconfiguration of the supply chain consists of a reorder policy.

15. In an embodiment, the method of any preceding embodiments is disclosed, further comprising training the model, the training comprising the steps of:
a. receiving a virtual representation of the state of the said supply chain, wherein the virtual representation of the state of the said supply chain comprises a simulated environment of the said supply chain updated with real-world data from the said supply chain, wherein said simulated environment comprises supply chain nodes and their data exchange processes, and wherein real-world data comprise data from databases, data lakes, data warehouses, cloud infrastructures, blockchain;
b. calculating a value of a reward function, wherein the value is associated to the obtained virtual representation of the state of the said supply chain;
c. providing said virtual representation of the state of the said supply chain with the calculated value of the reward function to the model, wherein the model comprises an optimizer;
d. running the optimizer, wherein running the optimizer comprises:
   i. obtaining at least one modified representation of the state of the said supply chain by taking at least one action on the provided virtual representation of the state of the said supply chain;
   ii. calculating at least one value of a reward function, wherein the value is associated to the at least one modified representation of the state of the said supply chain and to the at least one said action;
   iii. selecting from the said one or more actions an optimal action based on the value of the reward function associated to the said optimal action;
e. outputting the trained model, wherein the trained model comprises the selected optimal action.

16. In an embodiment, the method of any preceding embodiments is disclosed, further comprising training the model, the training consisting of the steps of:
a. receiving a virtual representation of the state of the said supply chain, wherein the virtual representation of the state of the said supply chain comprises a simulated environment of the said supply chain updated with real-world data from the said supply chain, wherein said simulated environment comprises supply chain nodes and their data exchange processes, and wherein real-world data comprise data from databases, data lakes, data warehouses, cloud infrastructures, blockchain;
b. calculating a value of a reward function, wherein the value is associated to the obtained virtual representation of the state of the said supply chain;
c. providing said virtual representation of the state of the said supply chain with the calculated value of the reward function to the model, wherein the model comprises an optimizer;
d. running the optimizer, wherein running the optimizer comprises:
   i. obtaining at least one modified representation of the state of the said supply chain by taking at least one action on the provided virtual representation of the state of the said supply chain;
   ii. calculating at least one value of a reward function, wherein the value is associated to the at least one modified representation of the state of the said supply chain and to the at least one said action;
   iii. selecting from the said one or more actions an optimal action based on the value of the reward function associated to the said optimal action;
   iv. outputting the trained model, wherein the trained model comprises the selected optimal action.

17. In an embodiment, the method of any preceding embodiments is disclosed, further comprising training the model, the training comprising the steps of:
a. receiving a virtual representation of the state of the said supply chain, wherein the virtual representation of the state of the said supply chain comprises a simulated environment of the said supply chain updated with real-world data from the said supply chain, wherein said simulated environment comprises supply chain nodes and their data exchange processes, and wherein real-world data comprise data from databases, data lakes, data warehouses, cloud infrastructures, blockchain;
b. calculating a value of a reward function, wherein the value is associated to the obtained virtual representation of the state of the said supply chain;
c. providing said virtual representation of the state of the said supply chain with the calculated value of the reward function to the model, wherein the model comprises an optimizer;
d. running the optimizer, wherein running the optimizer consists of:
   i. obtaining at least one modified representation of the state of the said supply chain by taking at least one action on the provided virtual representation of the state of the said supply chain;
   ii. calculating at least one value of a reward function, wherein the value is associated to the at least one modified representation of the state of the said supply chain and to the at least one said action;
   iii. selecting from the said one or more actions an optimal action based on the value of the reward function associated to the said optimal action;
e. outputting the trained model, wherein the trained model comprises the selected optimal action.

18. In an embodiment, the method of any preceding embodiments is disclosed, further comprising training the model, the training consisting of the steps of:
a. receiving a virtual representation of the state of the said supply chain, wherein the virtual representation of the state of the said supply chain comprises a simulated environment of the said supply chain updated with real-world data from the said supply chain, wherein said simulated environment comprises supply chain nodes and their data exchange processes, and wherein real-world data comprise data from databases, data lakes, data warehouses, cloud infrastructures, blockchain;
b. calculating a value of a reward function, wherein the value is associated to the obtained virtual representation of the state of the said supply chain;
c. providing said virtual representation of the state of the said supply chain with the calculated value of the reward function to the model, wherein the model comprises an optimizer;
d. running the optimizer, wherein running the optimizer consisting of:
   i. obtaining at least one modified representation of the state of the said supply chain by taking at least one action on the provided virtual representation of the state of the said supply chain;
   ii. calculating at least one value of a reward function, wherein the value is associated to the at least one modified representation of the state of the said supply chain and to the at least one said action;
   iii. selecting from the said one or more actions an optimal action based on the value of the reward function associated to the said optimal action;
e. outputting the trained model, wherein the trained model comprises the selected optimal action.

19. In an embodiment, the method of any of embodiments 15-18 is disclosed, wherein the steps are performed sequentially.

20. In an embodiment, the method of any of embodiments 15-19 is disclosed, wherein the steps are performed in order.

21. In an embodiment, the method of any of embodiments 15-20 is disclosed, wherein the real-world data are received at regular intervals.

22. In an embodiment, the method of any of embodiments 15-21 is disclosed, wherein the supply chain nodes comprise internet of things, industrial internet of things, cyberphysical systems.

23. In an embodiment, the method of any of embodiments 15-22 is disclosed, wherein the supply chain nodes consist of internet of things, industrial internet of things, cyberphysical systems.

24. In an embodiment, the method of any of embodiments 15-23 is disclosed, wherein the supply chain nodes data exchange processes are data from databases, data lakes, data warehouses, cloud infrastructures, blockchain.

25. In an embodiment, the method of any of embodiments 15-24 is disclosed, wherein the simulated virtual environment is Markovian.

26. In an embodiment, the method of any of embodiments 15-25 is disclosed, wherein the virtual representation is a digital twin.

27. A computer-implemented method to generate a supply chain digital twin for a multi-distribution-level supply chain optimization, wherein the method comprises the steps of:
a. receiving data from the said supply chain, wherein the data comprise the supply chain nodes and their data exchange processes, and wherein the supply chain nodes comprise internet of things, industrial internet of things, cyberphysical systems, and wherein the data exchange processes are data from databases, data lakes, data warehouses, cloud infrastructures, blockchain;
b. simulating a virtual environment of the said supply chain based on the received data;
c. receiving from the said supply chain at least once real-time data, wherein the real-time data comprise data from databases, data lakes, data warehouses, cloud infrastructures, blockchain;
d. outputting a digital twin of the said supply chain, wherein the digital twin comprises a virtual representation of the state of the said supply chain, wherein the virtual representation of the state of the said supply chain comprises the simulated virtual environment of the said supply chain updated at least once with the received at least once real-time data.

28. A computer-implemented method to generate a supply chain digital twin for a multi-distribution-level supply chain optimization, wherein the method consists of the steps of:
a. receiving data from the said supply chain, wherein the data comprise the supply chain nodes and their data exchange processes, and wherein the supply chain nodes comprise internet of things, industrial internet of things, cyberphysical systems, and wherein the data exchange processes are data from databases, data lakes, data warehouses, cloud infrastructures, blockchain;
b. simulating a virtual environment of the said supply chain based on the received data;
c. receiving from the said supply chain at least once real-time data, wherein the real-time data comprise data from databases, data lakes, data warehouses, cloud infrastructures, blockchain;
d. outputting a digital twin of the said supply chain, wherein the digital twin comprises a virtual representation of the state of the said supply chain, wherein the virtual representation of the state of the said supply chain comprises the simulated virtual environment of the said supply chain updated at least once with the received at least once real-time data.

29. In an embodiment, the method of any of embodiments 27-28 is disclosed, wherein the steps are performed sequentially.

30. In an embodiment, the method of any of embodiments 27-29 is disclosed, wherein the steps are performed in order.

31. In an embodiment, the method of any of embodiments 27-30 is disclosed, wherein the real-time data are received at regular intervals.

32. In an embodiment, a computer program product is disclosed comprising instructions which, when the program is executed by a computer, cause the computer to carry out the steps of:
a. obtaining a state of the said supply chain, wherein the state is determined based on real-time data from the supply chain, wherein real-time data comprise data from databases, data lakes, data warehouses, cloud infrastructures, blockchain;
b. calculating a value of a reward function, wherein the value is associated to the state of the said supply chain;
c. providing the state of the said supply chain with the calculated value of the reward function to a trained model;
d. receiving from the trained model an optimal action, wherein the optimal action is associated with the provided state of the said supply chain and the calculated value of the reward function;
e. updating the state of the said supply chain with the optimal action.

33. In an embodiment, a computer program product is disclosed consisting of instructions which, when the program is executed by a computer, cause the computer to carry out the steps of:
a. obtaining a state of the said supply chain, wherein the state is determined based on real-time data from the supply chain, wherein real-time data comprise data from databases, data lakes, data warehouses, cloud infrastructures, blockchain;
b. calculating a value of a reward function, wherein the value is associated to the state of the said supply chain;
c. providing the state of the said supply chain with the calculated value of the reward function to a trained model;
d. receiving from the trained model an optimal action, wherein the optimal action is associated with the provided state of the said supply chain and the calculated value of the reward function;
e. updating the state of the said supply chain with the optimal action.

34. In an embodiment, a computer-readable storage medium comprising instructions which, when the program is executed by a computer, cause the computer to carry out the steps of:
a. obtaining a state of the said supply chain, wherein the state is determined based on real-time data from the supply chain, wherein real-time data comprise data from databases, data lakes, data warehouses, cloud infrastructures, blockchain;
b. calculating a value of a reward function, wherein the value is associated to the state of the said supply chain;
c. providing the state of the said supply chain with the calculated value of the reward function to a trained model;
d. receiving from the trained model an optimal action, wherein the optimal action is associated with the provided state of the said supply chain and the calculated value of the reward function;
e. updating the state of the said supply chain with the optimal action.

35. In an embodiment, a computer-readable storage medium consisting of instructions which, when the program is executed by a computer, cause the computer to carry out the steps of:
a. obtaining a state of the said supply chain, wherein the state is determined based on real-time data from the supply chain, wherein real-time data comprise data from databases, data lakes, data warehouses, cloud infrastructures, blockchain;
b. calculating a value of a reward function, wherein the value is associated to the state of the said supply chain;
c. providing the state of the said supply chain with the calculated value of the reward function to a trained model;
d. receiving from the trained model an optimal action, wherein the optimal action is associated with the provided state of the said supply chain and the calculated value of the reward function;
e. updating the state of the said supply chain with the optimal action.

36. In an embodiment, a system is disclosed comprising:
a. an input/output (I/O) unit configured to receive data, wherein data comprises real-time data;
b. a processor configured to perform the steps of:
   i. obtaining a state of the said supply chain, wherein the state is determined based on real-time data from the supply chain, wherein real-time data comprise data from databases, data lakes, data warehouses, cloud infrastructures, blockchain;
   ii. calculating a value of a reward function, wherein the value is associated to the state of the said supply chain;
   iii. providing the state of the said supply chain with the calculated value of the reward function to a trained model;
   iv. receiving from the trained model an optimal action, wherein the optimal action is associated with the provided state of the said supply chain and the calculated value of the reward function;
   v. updating the state of the said supply chain with the optimal action.

37. In an embodiment, a system is disclosed consisting of:
a. an input/output (I/O) unit configured to receive data, wherein data comprises real-time data;
b. a processor configured to perform the steps of:
   i. obtaining a state of the said supply chain, wherein the state is determined based on real-time data from the supply chain, wherein real-time data comprise data from databases, data lakes, data warehouses, cloud infrastructures, blockchain;
   ii. calculating a value of a reward function, wherein the value is associated to the state of the said supply chain;
   iii. providing the state of the said supply chain with the calculated value of the reward function to a trained model;
   iv. receiving from the trained model an optimal action, wherein the optimal action is associated with the provided state of the said supply chain and the calculated value of the reward function;
   v. updating the state of the said supply chain with the optimal action.

The present disclosure includes the combination of the aspects and preferred features as described except where such a combination is clearly impermissible or expressly avoided.

Where lists are part of the aspects and preferred features as described, the present disclosure includes the combination of the elements of such lists as well as the individual elements of the list as alternatives.

It must be noted, as used in the specification and the appended claims, the singular forms ‘a’, ‘an’, and ‘the’ include plural referents unless the context clearly dictates otherwise.

Throughout this specification, including the claims which follow, unless the context requires otherwise, the word ‘comprise,’ and variations such as ‘comprises’ and ‘comprising,’ will be understood to imply the inclusion of a stated integer or step or group of integers or steps but not the exclusion of any other integer or step or group of integers or steps.

The section headings used herein are for organizational purposes only and are not to be construed as limiting the subject matter described.

1. A computer-implemented method for optimizing a multi-distribution-level supply chain, wherein the method comprises:
a. obtaining a state of the said supply chain (602), wherein the state is determined based on real-time data from the supply chain, wherein real-time data comprise data from databases, data lakes, data warehouses, cloud infrastructures, blockchain;
b. calculating a value of a reward function (604), wherein the value is associated to the state of the said supply chain;
c. providing the state of the said supply chain with the calculated value of the reward function to a trained model (606);
d. receiving from the trained model an optimal action (608), wherein the optimal action is associated with the provided state of the said supply chain and the calculated value of the reward function;
e. updating the state of the said supply chain with the optimal action (610).

2. The method of claim 1, wherein the multi-distribution-level supply chain is a multi-echelon supply chain.

3. The method of claim 1, wherein the reward function is a target cost function.

4. The method of claim 1, wherein the model comprises a deep reinforcement learning model.

5. The method of claim 1, wherein the optimal action comprises a sequence of one or more steps of a reconfiguration of the supply chain.

6. The method of claim 5, wherein the reconfiguration of the supply chain comprises a reorder policy.

7. The method of claim 1, further comprising training the model, the training comprising the steps of:
a. receiving a virtual representation of the state of the said supply chain (702), wherein the virtual representation of the state of the said supply chain comprises a simulated environment of the said supply chain updated with real-world data from the said supply chain, wherein said simulated environment comprises supply chain nodes and their data exchange processes, and wherein real-world data comprise data from databases, data lakes, data warehouses, cloud infrastructures, blockchain;
b. calculating a value of a reward function (704), wherein the value is associated to the obtained virtual representation of the state of the said supply chain;
c. providing said virtual representation of the state of the said supply chain with the calculated value of the reward function to the model (706), wherein the model comprises an optimizer;
d. running the optimizer (708), wherein running the optimizer comprises:
i. obtaining at least one modified representation of the state of the said supply chain by taking at least one action on the provided virtual representation of the state of the said supply chain;
ii. calculating at least one value of a reward function, wherein the value is associated to the at least one modified representation of the state of the said supply chain and to the at least one said action;
iii. selecting from the said one or more actions an optimal action based on the value of the reward function associated to the said optimal action;
e. outputting the trained model (710), wherein the trained model comprises the selected optimal action.

8. The method of claim 7, wherein the supply chain nodes comprise internet of things, industrial internet of things, cyberphysical systems, wherein the supply chain nodes data exchange processes are data from databases, data lakes, data warehouses, cloud infrastructures, blockchain.

9. The method of claim 7, wherein the simulated virtual environment is Markovian.

10. The method of claim 7, wherein the virtual representation is a digital twin.

11. A computer-implemented method to generate a supply chain digital twin for a multi-distribution-level supply chain optimization, wherein the method comprises the steps of:
a. receiving data from the said supply chain (802), wherein the data comprise the supply chain nodes and their data exchange processes, and wherein the supply chain nodes comprise internet of things, industrial internet of things, cyberphysical systems, and wherein the data exchange processes are data from databases, data lakes, data warehouses, cloud infrastructures, blockchain;
b. simulating a virtual environment of the said supply chain based on the received data (804);
c. receiving from the said supply chain at least once real-time data (806), wherein the real-time data comprise data from databases, data lakes, data warehouses, cloud infrastructures, blockchain;
d. outputting a digital twin of the said supply chain (808), wherein the digital twin comprises a virtual representation of the state of the said supply chain, wherein the virtual representation of the state of the said supply chain comprises the simulated virtual environment of the said supply chain updated at least once with the received at least once real-time data.

12. (canceled)

13. A computer-readable storage medium comprising instructions which, when the program is executed by a computer, cause the computer to carry out the steps of:
a. obtaining a state of the said supply chain, wherein the state is determined based on real-time data from the supply chain, wherein real-time data comprise data from databases, data lakes, data warehouses, cloud infrastructures, blockchain;
b. calculating a value of a reward function, wherein the value is associated to the state of the said supply chain;
c. providing the state of the said supply chain with the calculated value of the reward function to a trained model;
d. receiving from the trained model an optimal action, wherein the optimal action is associated with the provided state of the said supply chain and the calculated value of the reward function;
e. updating the state of the said supply chain with the optimal action.

14. A system comprising:
a. an input/output (I/O) unit (202) configured to receive data, wherein data comprises real-time data;
b. a processor (204) configured to perform the steps of:
i. obtaining a state of the said supply chain, wherein the state is determined based on real-time data from the supply chain, wherein real-time data comprise data from databases, data lakes, data warehouses, cloud infrastructures, blockchain;
ii. calculating a value of a reward function, wherein the value is associated to the state of the said supply chain;
iii. providing the state of the said supply chain with the calculated value of the reward function to a trained model;
iv. receiving from the trained model an optimal action, wherein the optimal action is associated with the provided state of the said supply chain and the calculated value of the reward function;
v. updating the state of the said supply chain with the optimal action.

15. (canceled)
